(19) United States
(12) Patent Application Publication
(10) Pub. No.: US 2011/0003226 A1
(43) Pub. Date: Jan. 6, 2011

(54) FUEL CELL APPARATUS AND METHOD OF FABRICATION

(76) Inventors: Larry J. Markoski, Raleigh, NC (US); Dilip Natarajan, Cary, NC (US); Alex Primak, Cary, NC (US)

Correspondence Address: EVAN LAW GROUP LLC, 600 WEST JACKSON BLVD., SUITE 625, CHICAGO, IL, 60661, US

(21) Appl. No.: 12/828,223

(22) Filed: Jun. 30, 2010

Related U.S. Application Data
(63) Continuation of application No. 11/067,463, filed on Feb. 24, 2005, now abandoned.

(51) Int. Cl. H01M 8/04; H01M 4/88; H01M 8/24

(52) U.S. Cl. 429/444; 429/535; 429/457

(57) ABSTRACT

A fuel cell is described. The fuel cell includes current collectors, each of which includes a substrate of lightweight material, such as Kapton material. Micro channels are formed via laser machining or chemical etching into the substrate. The current collectors further include conductive layers sputtered on the substrate, and protective coating on the conductive layers. A variety of materials are available for the conductive layers. The fuel cell so developed is particularly well suited to mobile applications, such as electronic devices.

### CROSS-REFERENCE TO RELATED APPLICATIONS

The present invention claims priority to Markoski's U.S. provisional patent application No. 60/547,618, filed Feb. 24, 2004, entitled FUEL CELL APPARATUS AND METHOD OF FABRICATION, the entire contents of which are incorporated herein by reference.

### BACKGROUND OF THE INVENTION

1. Field of the Invention

The present invention relates to fuel cells. More specifically, the present invention teaches a variety of in-plane fuel cell current collectors embedded on flexible lightweight substrates and coupled to lightweight flow distributors, and methods for manufacturing same.

2. Discussion of the Related Art

Existing renewable power sources for low-power devices, such as handheld electronics or other portable devices, have failed to keep pace with the increasing sophistication of such electronics. The power sources currently employed in mobile devices, including various types of chemical batteries such as lithium ion or nickel cadmium batteries, are unwieldy, generate insufficient power for inadequately short duration, and require untenably long recharge periods. These limitations impose severe restrictions on the functionality of the devices they power: e.g., users are forced to recharge units at untenably short intervals, and the weight of existing batteries renders mobile devices much larger and heavier than desirable. The dichotomy between the rapid progress in electronics and the relative torpor in power technologies grows progressively more pronounced, as electronics technology continue to advance at geometric rates for the foreseeable future.

Efforts have been undertaken to replace or enhance existing, antiquated battery technologies for the types of applications discussed above. Amongst the more promising candidates for renewable, portable energy provision are miniature, or “micro” fuel cells, and in particular, Polymer Electrolyte Membrane (PEM) fuel cells due to their low operating temperature (i.e. <120° C.) and potential for high energy density due to the use of atmospheric oxygen as the oxidant which does not add to the overall system weight.

PEM fuel cells can be broken down into different types depending on the chemical composition of the fuel that is used in the system. If pure hydrogen is used as the fuel the type is hydrogen PEM. If a hydrocarbon fuel such as butane or methanol is

TABLE 1
½ Cell potentials of oxidants and fuels that can be utilized directly in
PEM based fuel cells

| | |
|---|---|
| O₂(g) + 4H⁺ + 4e⁻ [symbol] 2H₂O | +1.23 V |
| H₂(g) [symbol] 2H⁺ + 2e | +0.00 V |
| CO₂(g) + 6H⁺ + 6e⁻ [symbol] CH₃OH + H₂O | +0.02 V |
| CO₂(g) + 2H⁺ + 2e⁻ [symbol] HCOOH | −0.20 V |

reformed to produce hydrogen from an onboard reformer, the type is a reformed hydrogen PEM. If a hydrocarbon based fuel such as methanol or formic acid is used as fuels without reforming to hydrogen, the type is direct liquid PEMs. A liquid methanol fuel cell, the most popular type fuel used directly without reforming, is typically referred to as a direct methanol fuel cell (DMFC). However, formic acid has been also shown to be a good direct fuel for PEMs.

Prior Art FIG. 1 illustrates a cross-sectional schematic diagram of an assembled and sealed single polymer electrolyte membrane (PEM) fuel cell 100. Table 1 (shown above) shows the half-cell potentials for the fuels discussed above, whose potential energy can be converted into electric energy when combined with oxygen within the PEM fuel cell 100. The PEM fuel cell 100 includes a membrane electrode assembly (MEA) 102, an anode current collector/flow distributor 104, and a cathode current collector/flow distributor 106. The MEA 102 is where all of the electric energy is released.

The current collectors/flow distributors 104 and 106 are electrically conductive and resistant to the corrosive fuel cell environment and are typically machined graphite with various flow channels (such as anode flow channel 108 and cathode flow channel 110) and patterns known in the art. The current collectors/flow distributors 104 and 106 can be used as both end plates and bipolar plates in PEM stacks. The channel dimensions and flow patterns can vary depending upon the application but for the most part both anode and cathode channels are 1.0-2.5 mm in height and width and the anode and cathode shoulders are typically 1.0-2.5 mm in height and width. The thickness between the bottom of the anode and cathode channels, called the web thickness needs to be 1 mm or greater to ensure mechanical robustness of the brittle graphite material and also ensure that the fuel and oxidant don't mix through the somewhat porous graphite web. This produces an overall thickness of 3-7.5 mm for the graphite based bi-polar plate design. Those skilled in the art will recognize that the majority of the volume and weight of the PEM stack comes from the current collectors/flow distributors 104 and 106.

As shown in Prior Art FIG. 2, the MEA 102 includes a polymer electrolyte membrane 120 capable of conducting protons and insulating electrons is sandwiched between two platinum based catalyst layers 122 and 124, and two porous gas/fuel diffusion electrodes (GDEs) 126 and 128. The PEM 120 can take any suitable form, such as a Nafion ionmer based material with thickness ranging from 25-250 micrometers. The anode catalyst layer 122 is typically supported or unsupported Pt or Pt alloy with precious metal loadings ranging from 0.1-10 mg/cm² depending on fuel used and desired current density. The cathode catalyst layer 124 is typically supported or unsupported Pt with loadings ranging from 0.1-10 mg/cm² depending on fuel used and desired current density. The GDEs 126 and 128 are typically graphite based (Torray paper) with coatings added to increase or decrease hydrophobiticy and porosity ranging from 5-80% and thickness ranging from 50-350 micrometers in thickness.

In a fully assembled and operational single cell PEM fuel cell 102 (see FIGS. 1-2), electricity is created as a result of fuel coming in contact with the anode catalyst where the fuel is decomposed into protons, electrons, and carbon dioxide if a carbon based fuel is used (see Table 1.) These protons flow through the PEM 120 while the electrons can only flow via the anode current collector 104 out through an external load 112 and into the cathode current collector 106 where the electrons recombine in the cathode catalyst layer with protons and oxygen to produce water; this completes the electric circuit, in so doing performing electrochemical work.

By stacking numerous PEM cells 100 together as shown in Prior Art FIG. 3, a fuel cell stack power source system 150 capable of use in aerospace and automotive applications can be built. Such power systems have been studied widely at power levels of 10,000 watts and above and have been engineered to produce high power density systems. These systems consist of three components, the fuel, the fuel cell stack 150 and the balance of plant (BOP). The BOP is responsible for controlling the performance of the fuel cell stack by distributing and conditioning the fuel, air, and cooling streams that run through the fuel cell stack.

The fuel cell stack 150 of FIG. 3 can be controlled to operate at high power density or high energy density (high fuel efficiency). This is illustrated graphically in a current/voltage plot 160 as shown graphically in FIG. 4. Here the potential losses fall into three regimes: an activation region 162, an Ohmic region 164 and a transport region 166. The shape and slope of the activation region 162 is determined by the activity and performance of the catalyst layers. The shape and slope of the Ohmic region 164 is determined by the sum of the internal cell resistances (ionic and electrical). The shape and slope of the transport region 166 is determined by the rate at which fuel and oxidant are supplied to the fuel cell stack.

Prior Art FIG. 5 provides a graphical representation 170 of how increasing the fuel to system ratio for a given power requirement (e.g., 20 Watts) serves to increase the specific energy density for a PEM based power system 150. As will be appreciated, at a given temperature and BOP operating conditions, the maximum power (watts) a fuel cell stack 150 can deliver occurs at the maximum product value of the potential (volts) and the current density (mA/cm²). To increase the energy density of the system, the stack 150 can be operated at higher voltage, at an optimal point between the open circuit voltage (zero current), and the maximum power voltage. Alternatively or in conjunction with, for a given stack power output and system weight/volume, FIG. 9 illustrates how the energy density can be increased by decreasing the size and weight of the BOP and fuel cell stack while increasing the amount of fuel.

While increasing the energy density for PEM systems is relative easy to achieve for large systems, decreasing the size and weight of the BOP and fuel cell stack 150 has been shown to be somewhat problematic for sub 100 Watt levels. Inefficiency can be at least partially attributed to the volume of the fuel cell stack within these low power PEM fuel cell systems. Moreover, such stacks are physically weighty, by virtue of the thick machined graphite bipolar plates and end plates typically used in construction. This feature of the prior art PEM fuel cell technology is particularly problematic for mobile devices, for which low weight/volume form factors constitute a critical selling feature.

Thus, the prior art evinces a need for reducing the size and weight of PEM fuel cell stacks and systems for application to low power products, such as handheld mobile devices, laptop computers, or other such applications. More specifically the prior art evinces a need for reducing the size and weight of PEM fuel cell stacks by replacing machined graphite bipolar plates and end plates with flexible lightweight, low density composites of corrosion resistant materials with adequate electrical conductivity (See table 2). Such fuel cell systems should produce power efficiently (e.g., have high energy density), in order to support sufficiently lengthy operational duration. Moreover, to enhance the suitability of fuel cells for intended applications (such as mobile electronic devices), it is desirable that such fuel cell systems be lightweight and inexpensive. Moreover, it is desirable for such devices to be manufacturable through low cost, efficient processes. These and other objectives of the present invention are addressed as further discussed herein.

TABLE 2
List of electrically conductive materials and
corresponding physical properties

| | | | | Conduct- | Resis- |
|---|---|---|---|---|---|
| | | Atomic | Density | ivity | tivity |
| Metal | Symbol | Weight | (gcm⁻³) | (S/cm) | (Ωm) |
| Silver | Ag | 107.868 | 10.49 | 630100 | 1.59E-08 |
| Copper | Cu | 63.546 | 8.92 | 596100 | 1.68E-08 |
| Gold | Au | 196.9665 | 19.3 | 452100 | 2.21E-08 |
| Aluminum | Al | 26.98152 | 2.7 | 377100 | 2.65E-08 |
| Rhodium | Rh | 102.9055 | 12.45 | 211100 | 4.51E-08 |
| Molybdenum | Mo | 95.94 | 10.28 | 187100 | 5.34E-08 |
| Tungsten | W | 183.85 | 19.25 | 18910 | 5.40E-08 |
| Nickel | Ni | 58.6934 | 8.908 | 143100 | 6.99E-08 |
| Ruthenium | Ru | 101.07 | 12.37 | 137100 | 7.10E-08 |
| Iron | Fe | 55.847 | 7.874 | 99310 | 9.71E-08 |
| Palladium | Pd | 106.42 | 12.023 | 95010 | 1.05E-07 |
| Platinum | Pt | 195.08 | 21.45 | 96610 | 1.06E-07 |
| Chromium | Cr | 51.996 | 7.14 | 77410 | 1.29E-07 |
| Tantalum | Ta | 180.9479 | 16.65 | 76110 | 1.35E-07 |
| Niobium | Nb | 92.9064 | 8.57 | 69310 | 1.44E-07 |
| Rhenium | Re | 186.207 | 21.02 | 54210 | 1.84E-07 |
| Titanium | Ti | 47.88 | 4.507 | 23410 | 4.20E-07 |
| Graphite | C | 12.0107 | 1.25 | 500-700 | 2.00E-05 |

### SUMMARY OF THE INVENTION

The invention teaches a variety of fuel cell, fuel cell stack systems, and fuel cell power systems, as well as techniques and mechanisms for manufacturing such devices. Certain embodiments of the present invention offer dramatic improvements over prior art fuel cell technologies in system performance, usability, and expense. In particular, certain fuel cells of the present invention demonstrate efficiency, are lightweight, relatively easy to manufacture, and cost-effective to produce and distribute. These embodiments are particularly well-suited to micro fuel cell applications (100 watt and below) such as portable electronic devices, including lap top computers, personal digital assistants, mobile phones, and other such products. Other suitable applications for the fuel cells described herein shall be readily apparent to those skilled in the art.

In embodiments of the invention, the fuel cell power source may comprise a PEM based fuel cell stack. Some such embodiments include a current collector layer further comprised of a support layer, with a series of micro-channels etched through the support layer and current collector layer. In some such embodiments, the support layer may be comprised of a lightweight material; in embodiments, this lightweight material may be comprised of a Kapton-type material or other chemically resistant polymer thermoplastic films such as Imidex, PEEK, Vectra, PET, Teflon, Tefzel, HDPE Ultem or any other polymer films typically used in or compatible with the manufacture of flexible circuits. In some embodiments, the micro-channels are patterned onto the support layer through a lithographic photoresist process. In other embodiments, the micro-channels are etched through the support layer using a chemical etching process. In still other embodiments, the micro-channels are cut into the support layer through a photo machining process (i.e., laser cutting). In further embodiments, the micro-channels are punched into the support layer through a die cutting process.

The present invention also teaches a current collector having a thin adhesion layer opposite of the support layer. In certain embodiments, the adhesion layer may be a conductive metal layer or multilayer (10-2000 angstroms). The adhesion layer may be comprised partially of a platinum group metal such as platinum, palladium, ruthenium or rhodium, a coinage metal such as silver, gold, or copper a refractory metal such as niobium, rhenium, molybdenum, tungsten or tantalum, a metal such as aluminum, iron, nickel, or chromium, or a metal alloy such as Inconel, Monel, or stainless steels or any other such metallic based adhesive layer commonly employed or compatible with the metallization process in the flexible and/or printed circuit board manufacturing process. The adhesion layer deposition process may include sputtering, e-beam, or chemical vapor deposition processes. In alternative embodiments, the adhesion layer may be a chemically and thermally substantially stable polymer-based adhesive ranging in thickness from 25-250 um. The polymer-based adhesive can be a B-stage epoxy bond-ply layer, a thermo-setting liquid crystal polymer resin, a Teflon-like FEP or PFA film or any other polymer-based solid or liquid state adhesive commonly employed or compatible with the flexible and or printed circuit board manufacturing process.

In embodiments of the invention, the current collector further includes a thicker highly conductive metallic layer or multilayer adhered/bonded/deposited onto the adhesion surface of the support layer. In some such embodiments, the conductive layer may be comprised at least partially of a platinum group metal such as platinum, palladium, ruthenium or rhodium, a coinage metal such as silver, gold, or copper a refractory metal such as niobium, rhenium, molybdenum, tungsten or tantalum, a metal such as aluminum, iron, nickel, or chromium, a metal alloy such as Inconel, Monel, or stainless steels or any other such metallic based adhesive layer commonly employed or compatible with the metallization and electrodeposition processes in the flexible and/or printed circuit board manufacturing process

According to certain manufacturing aspects of the invention, the conductive layer is deposited onto the adhesion layer via a sputtering or e-beam deposition process. In alternative aspects, the conductive layer is deposited onto the adhesion layer via or in conjunction with an electrodepostion process. In other embodiments, the conductive layer is a thin metal or metal alloy or thin low density flexible graphite bonded or clad to the opposite surface of the support layer through a cladding process commonly employed or compatible in the flexible and or printed circuit board manufacturing process.

In embodiments of the invention, the current collector further includes a conductive protective layer, formed on a surface of the highly conductive layer opposite the surface of the support layer. Such a protective layer protects the highly conductive layer of the current collector from at least one of oxidation and/or corrosion. In some such embodiments, the conductive protective layer may be comprised at least partially of a platinum group metal such as platinum, palladium, ruthenium or rhodium, a coinage metal such as silver or gold, a refractory metal such as niobium, rhenium, molybdenum, tungsten or tantalum. In alternative embodiments, the protective layer may be comprised at least partially of carbon or metallic particles dispersed within a polymer matrix. In some embodiments, the protective layer may be comprised at least partially of a conductive polymer. In other embodiments, the conductive polymer may be a polypyrrole, polythiophene or polyaniline.

According to certain manufacturing aspects of the invention, the protective conductive layer is deposited onto the highly conductive layer via a sputtering or e-beam deposition process. In alternative aspects, the conductive layer is deposited onto the adhesion layer via or in conjunction with an electrodepostion process In alternative embodiments of the present invention, the protective conductive layer is deposited onto the adhesion layer via a spray coating, dip coating or painting type process.

In embodiments of the invention, the fuel cell includes two lightweight flow distributors and two current collectors, with a membrane electrode assembly sandwiched between the two current collectors and lightweight flow distributors, such that one surface of the electrode assembly is in direct contact with one of the current collectors, and an opposite surface of the electrode assembly is in contact with the other current collectors. In embodiments of the invention the lightweight flow distributors are composed of chemically and thermally stable thermoplastics such as HDPE, Teflon, PEEK, Ultem, Kapton, or any other suitable thermoplastic. In other embodiments of the invention, the lightweight flow distributors are mechanically machined, alternatively, these flow distributors may be injection molded or blow molded. Alternatively, these flow distributors may be laser machined, or chemically etched.

### BRIEF DESCRIPTION OF THE FIGURES

Prior Art FIG. 1 is a cross-sectional schematic diagram of an assembled and sealed single polymer electrolyte membrane (PEM) fuel cell.

Prior Art FIG. 2 is a blow up of a cross-section of the membrane electrode assembly of FIG. 1.

Prior Art FIG. 3 is a diagram of a fuel cell stack of the prior art. Prior Art FIG. 4 is a graphical illustration of fuel cell potential versus current density.

Prior Art FIG. 5 is a graphical illustration of how increasing the fuel to system ration for a given power requirement serves to increase the specific energy density for a PEM based power system.

FIG. 6 is a schematic of a fuel cell stack according to one embodiment of the present invention.

FIG. 7 is an illustration of a 4-channel in-plane conductive composite end plate, anode or cathode.

FIG. 7A is a cross-sectional diagram of the end plate of FIG. 7.

FIG. 8 is an illustration of a 4-channel in-plane conductive composite bipolar plate.

FIG. 8A is a cross-sectional diagram of the bipolar plate of FIG. 8.

FIG. 9 is a cross-sectional view of a composite based current collector in accordance with one embodiment of the present invention.

FIG. 10 is a top view of a substrate of a current collector according to yet another embodiment of the present invention.

FIG. 11 is a flow chart of a method for the manufacture of a current collector in accordance with one aspect of the present invention.

### DETAILED DESCRIPTION

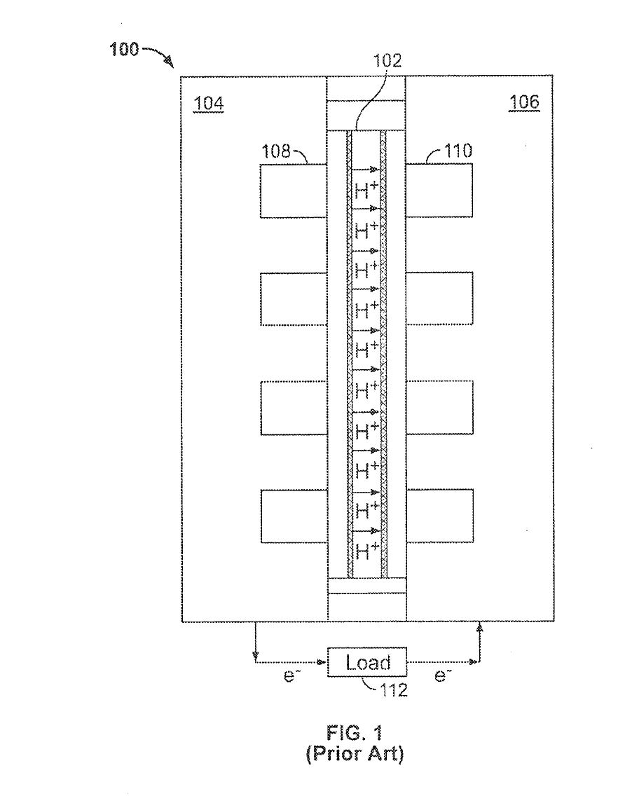

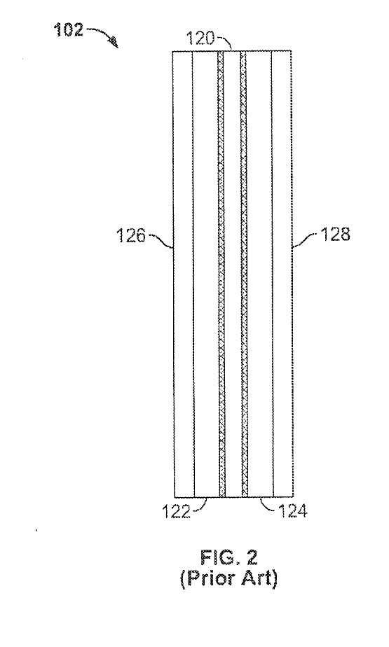

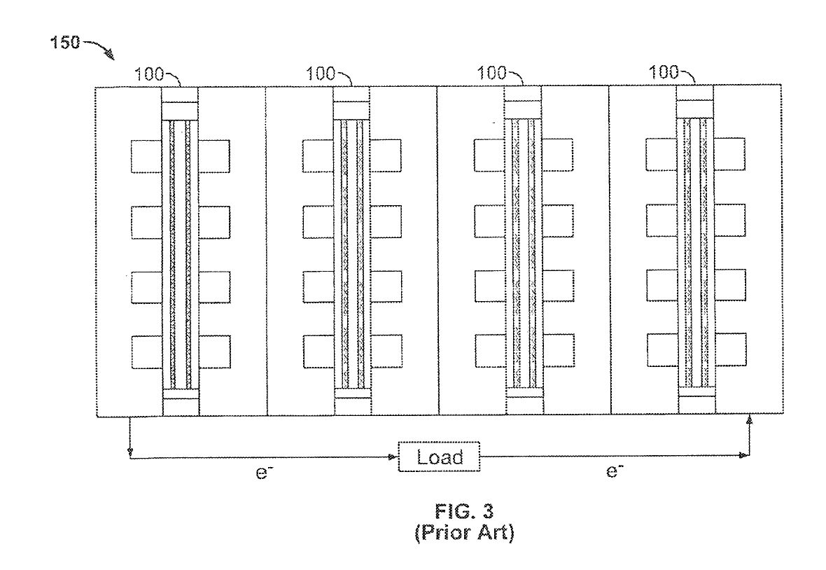

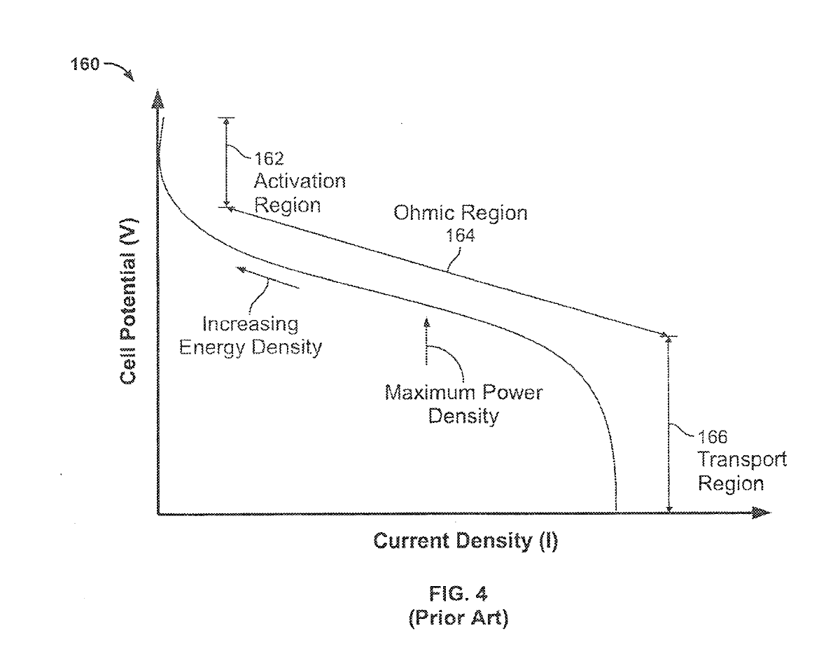

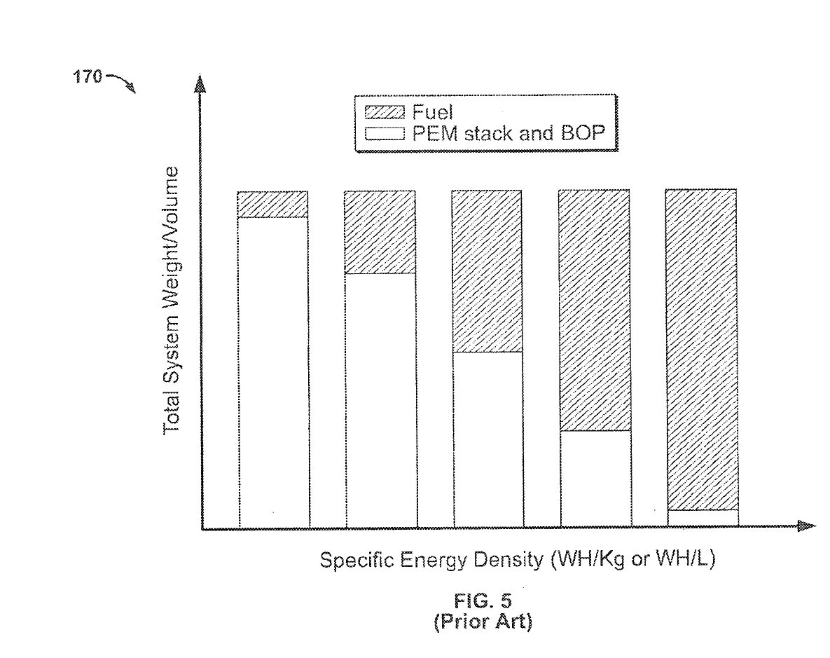

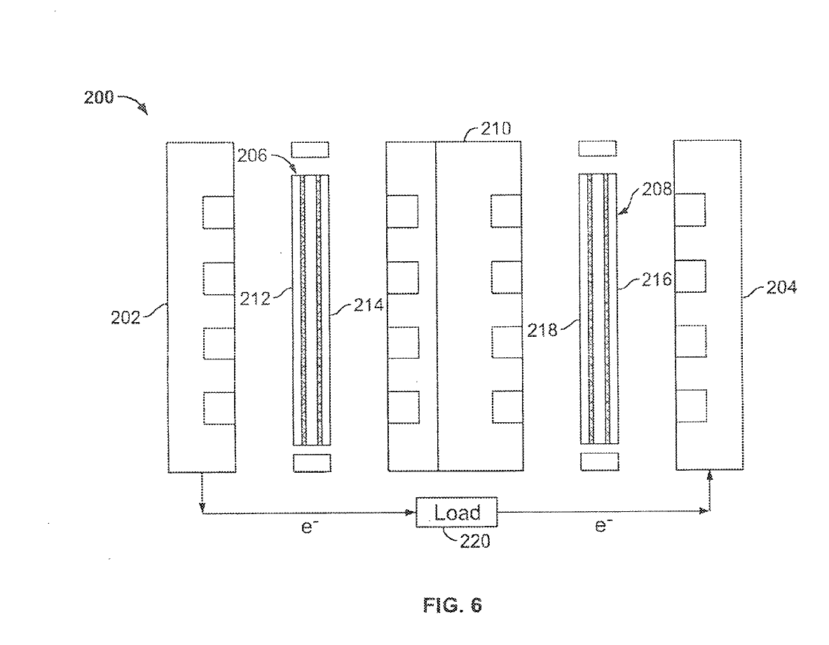

FIG. 6 illustrates schematically a design of a fuel cell stack 200 according to one embodiment of the present invention. The fuel cell stack 200 includes an anode end plate 202, a cathode end plate 204, two membrane electrode assemblies 206 and 208, and a bipolar plate 210. Opposite surfaces 212 and 214 of the MEA 206 are flush with conductive surfaces of the anode end plate 202 and the bipolar plate 210, respectively. Opposite surfaces 216 and 218 of the MEA 208 are flush with conductive surfaces of the cathode end plate 204 and the bipolar plate 210, respectively. (number).

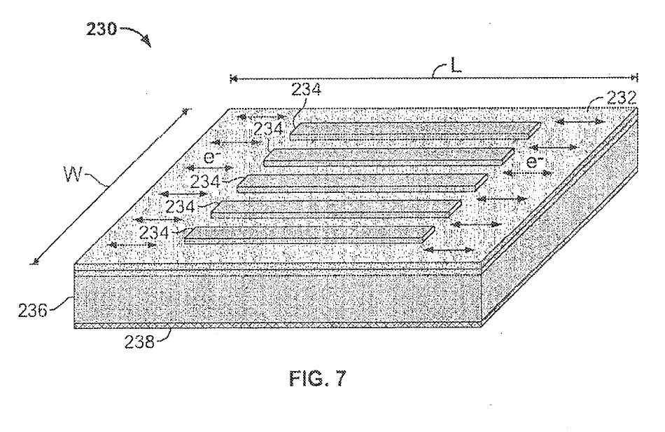

FIG. 7 illustrates a 4-channel in-plane conductive composite end plate 230 in accordance with one embodiment of the present invention. FIG. 7A provides a cross-sectional (side profile) schematic diagram of the 4-channel in-plane conductive composite end plate 230 of FIG. 7. As will be appreciated, the end plate 230 represents one possible generic configuration for both anode and cathode end plates such as anode end plate 202 and cathode end plate 204 of FIG. 6. The end plate 230 includes a current collector (anode or cathode) 232, a plurality of flow channels 234, a thermoplastic flow distributor 236, and a thermoplastic film web or separator 238.

With further reference to FIGS. 7 and 7A, the dimensions of the end plate 230 will depend upon the specific application. For example, the applicant contemplates a width W in the range of 2 cm-100 cm and a length L in the range of 2 cm-20 cm. The application further contemplates a channel height 240 in the range of 25 micrometers-2.5 mm, a channel width 242 in the range of 0.25 mm 2.5 mm, a shoulder width 244 in the range of 0.25 mm-2.5 mm, an overall thickness in the range of 75 micrometers-6.5 mm, and a web thickness 248 in the range of 25 micrometers-2.5 mm.

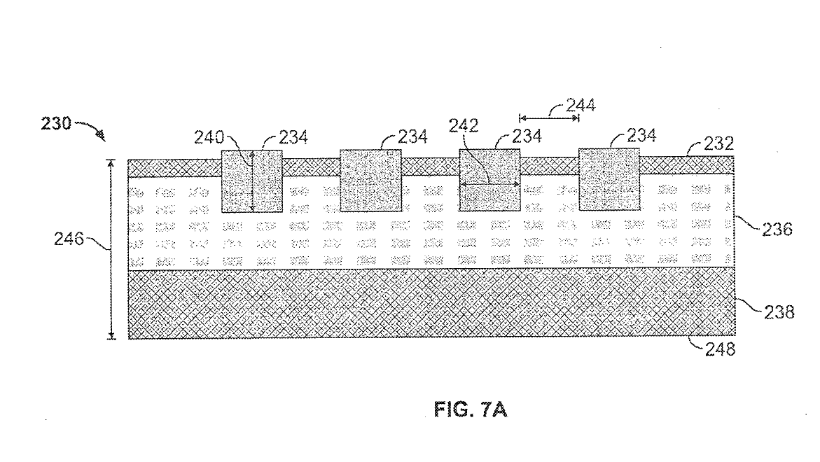

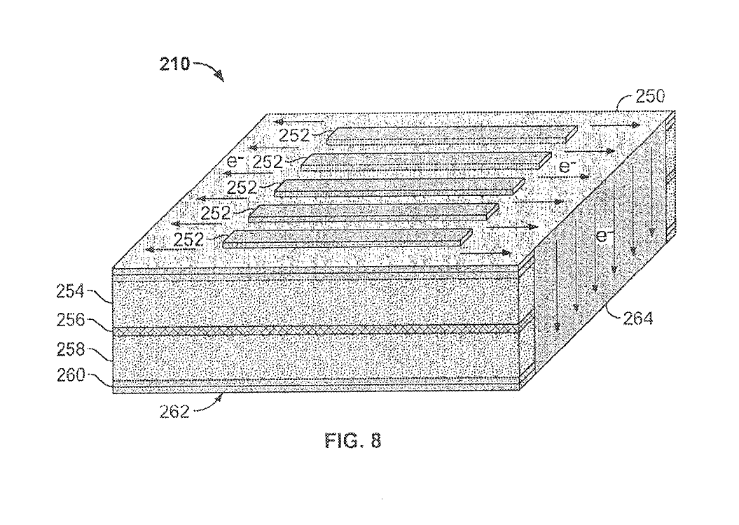

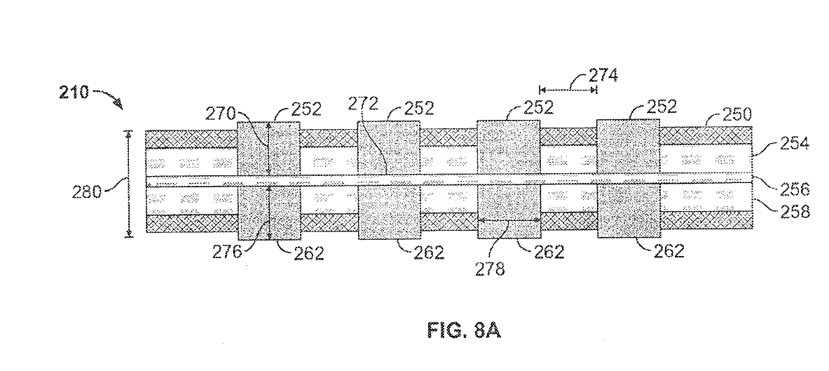

FIG. 8 illustrates a 4-channel in-plane conductive composite bipolar plate 210 in accordance with another embodiment of the present invention. FIG. 8A provides a cross-sectional (side profile) schematic diagram of the 4-channel in-plane conductive composite bipolar plate 210 of FIG. 8. The bipolar plate 210 includes an anode current collector 250, a plurality of anode flow channels 252 etched into the anode current collector 250, an anode thermoplastic flow distributor 254, a thermoplastic film web or separator 256, a cathode thermoplastic flow distributor 258, a cathode current collector 260, a plurality of cathode flow channels 262 (not fully shown in FIG. 8), and a low resistance external current collector connector 264.

With further reference to FIGS. 8 and 8A, the dimensions of the bipolar plate 210 will depend upon the specific application. For example, the Applicant contemplates an anode channel height 270 of 25 um-2.5 mm, a web thickness 272 of about 25 um-2.5 mm, a shoulder width 274 of about 0.25 mm-2.5 mm, a cathode channel height 276 of about 1.0 mm-2.5 mm, a channel width 278 of about 1.0 mm-2.5 mm and an overall thickness 280 of about 75 um-6.5 mm.

FIG. 9 illustrates a cross-sectional view of a composite based current collector 300 in accordance with one embodiment of the present invention. The current collector 300 includes a substrate (polymer film support layer) 302, an adhesive layer 304, a highly conductive layer 306, and a conductive protective layer 308.

The substrate 302 is preferably comprised of a lightweight material, i.e., a material lighter in weight than a comparable semiconductor, ceramic, metal, or high density graphite substrate. For example, the substrate 302 may include a thermoplastic film material such as Kapton, Imidex, PEEK, Vectra or any other lightweight suitable thermoplastic film material. Thermoplastic film materials are well understood in the art, and are used extensively for deployment in flexible circuits. Amongst other features, they are distinguished for their low manufacturing cost, high yield processing, and superior fatigue resistance. The thickness of the substrate 302 will depend upon the specific implementation, however the present invention contemplates substrate thickness of about 12 um-500 um.

The adhesive layer 304 may include any suitable conductive metal, metal alloy, or metal multilayer, such as platinum, palladium, ruthenium rhodium, silver, gold, copper niobium, rhenium, molybdenum, tungsten or tantalum, aluminum, iron, nickel, chromium, such as Inconel, Monel, or stainless steels. Many different non-conductive organic materials such as b-stage epoxies, bond-ply layers etc., may be suitable for inclusion in the adhesion layer. The thickness of the adhesive layer 304 will depend upon the specific implementation, and the present invention contemplates thicknesses of about 500 A-250 um.

The highly conductive layer 306 may be made including any suitable conductive metal, metal alloy, or metal multilayer, such as platinum, palladium, ruthenium rhodium, silver, gold, copper niobium, rhenium, molybdenum, tungsten or tantalum, aluminum, iron, nickel, chromium, such as Inconel, Monel, or stainless steels. The present invention contemplates thicknesses of the highly conductive layer 306 to be about 1 um-100 um.

The protective conductive layer 308 serves to protect the otherwise exposed surface of the current collector 300 from corrosion in the hostile fuel cell environment. The protective conductive layer 308 may be made including any suitable corrosion resistant conductive metal, metal alloy, or metal multilayer, such as platinum, palladium, ruthenium rhodium, gold, niobium, rhenium, molybdenum, tungsten or tantalum. Many different conductive organic coatings with carbon or metal particles dispersed within the polymer matrix may be suitable for inclusion in the protective conductive layer. The present invention contemplates thicknesses of the protective conductive layer 308 to be about 0.25 um-25 um.

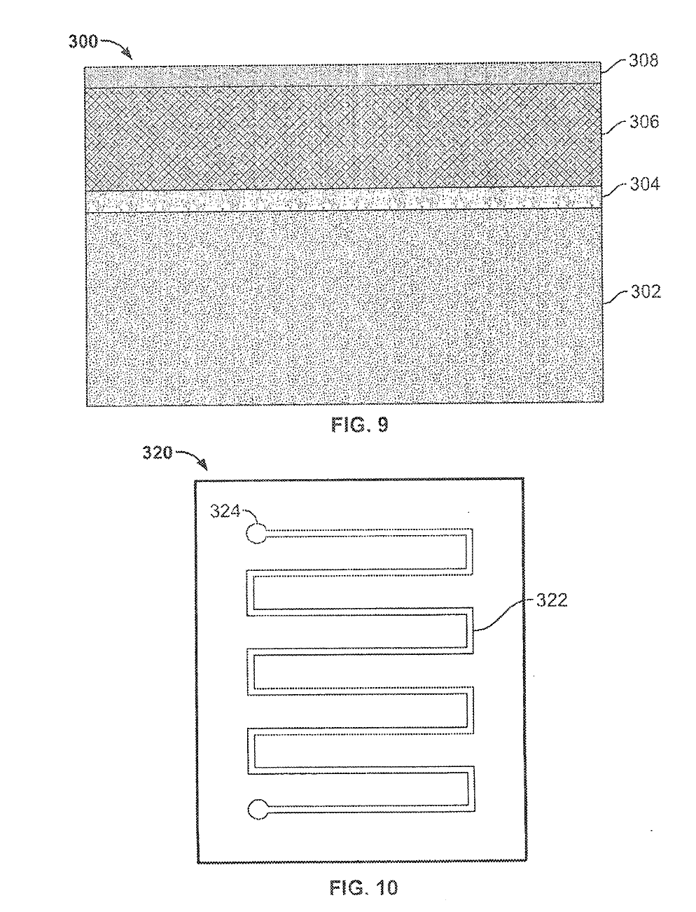

FIG. 10 illustrates a top view of a substrate 320 of a current collector in accordance with one embodiment of the present invention. The substrate 320 includes a series 322 of embedded microchannels. While the present invention contemplates any suitable shape and design for the microchannels, FIG. 10 illustrates a non-limiting single pass serpentine example formed into a Kapton-based substrate 320.

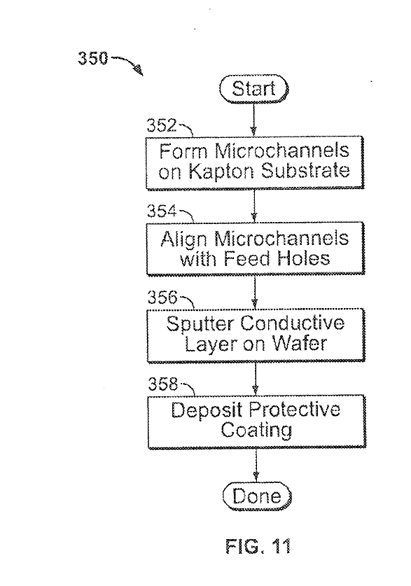

FIG. 11 illustrates a flow chart of a method 350 for the manufacture of a current collector in accordance with one aspect of the present invention. The manufacture commences with a process 352, which forms microchannels into the surface of a substrate of the current collector. As described above, the substrate includes a lightweight material, such as a Kapton material, and the process 352 is customized to the specific material. As will be appreciated, the microchannels may be formed via a laser machining process, a chemical etching process, a die stamp process, or any other process suitable to the material of the substrate. In some embodiments of the invention, the microchannels may comprise a serpentine microchannel 322 as illustrated in FIG. 10.

With further reference to FIG. 11, upon completion of the process 352, a next process 354 aligns the microchannels with feedholes such as feedholes 324 of FIG. 10. In certain embodiments of the invention, such alignment may be undertaken through a lithographic process. A subsequent process 356 sputters or forms a conductive layer the substrate. As described above with reference to FIG. 9, the conductive layer may be comprised of metals such as gold, platinum, or silver; alternatively, the conductive layer may be comprised of a conductive polymer, such as polypyrrole. In embodiments of the invention, a process 358 deposits a protective coating on the conductive layer, to protect from oxidation and/or corrosion. Note that these processes are offered as examples only, and alternative processes for manufacturing current collectors according to the present invention shall be apparent to those skilled in the art.

### Flow Distributors

In certain embodiments of the invention, the flow distributor of the plate is comprised of a lightweight material, i.e., a material lighter in weight than a comparable silicon, ceramic, semiconductor, graphite or metal, substrate such as HDPE, Teflon, PEEK, Ultem, Kapton, or any other suitable thermoplastic. The lightweight flow distributors may be mechanically machined, alternatively, these flow distributors may be injection molded or blow molded. Alternatively, these flow distributors may be laser machined, or chemically etched as previously described.

### Web/Separator

In certain embodiments of the invention, the web/separator of the plate is comprised of a lightweight material, i.e., a material lighter in weight than a comparable silicon, ceramic, semiconductor, graphite or metal, substrate such as HDPE, Teflon, PEEK, Ultem, Kapton, or any other suitable thermoplastic. The lightweight flow distributors may be mechanically machined, alternatively, these flow distributors may be injection molded or blow molded. Alternatively, these flow distributors may be laser machined, or chemically etched as previously described.

### CONCLUSION

The examples of fuel cells and manufacturing techniques discussed herein are for example, illustrative purposes only, and are not intended to limit the scope of the invention. Many modifications, alternative embodiments, and equivalents shall be apparent to those skilled in the art. In particular, substrates employed in current collectors according to embodiments of the present invention are not limited to Kapton or Kapton-type material, and may be comprised of any type of suitable, lightweight material.

1-11. (canceled)

12. A method of fabricating a current collector for a fuel cell, the method comprising:
providing a substrate of Kapton-type material;
forming a plurality of micro-channels in the substrate of Kapton-type material;
bonding, sputtering and/or electrodepositing a conductive layer on top of the substrate to form the current collector;
wherein a thickness of the conductive layer is less than 250 micrometers.

13. The method of claim 12, wherein the conductive layer includes at least one metallic material selected from the set consisting of platinum, palladium, ruthenium rhodium, silver, gold, copper niobium, rhenium, molybdenum, tungsten or tantalum, aluminum, iron, nickel, chromium or low density graphite

14. The method of claim 12, wherein the act of forming a plurality of micro-channels includes machining channels into the substrate.

15. The method of claim 14, wherein the machining is accomplished via laser machining.

16. The method of claim 12, where the act of forming a plurality of micro-channels includes chemically etching micro-channels in the substrate.

17. The method of claim 12, wherein the act of forming a plurality of micro-channels includes stamping micro-channels into the substrate.

18. A fuel cell comprising:
an anode current collector including a first support layer including a Kapton-type material, a first adhesive layer, a first highly conductive layer, and a first protective conductive layer, the anode current collector having a series of micro-channels etched into the first support layer;
an anode flow distributor coupled to the anode current collector, the anode flow distributor machined with a first pattern suitable to enable fuel to distribute across the anode current collector, the anode flow distributor including at least one of a thermoplastic material of HDPE, Teflon, PEEK Kapton, Upilex, Imidex, Vectra, or Ultem;
a cathode current collector including a second support layer including a Kapton-type material, a second adhesive layer, a second highly conductive layer, and a second protective conductive layer, the cathode current collector having a series of micro-channels etched into the second support layer;
a cathode flow distributor coupled to the cathode current collector, the cathode flow distributor machined with a second pattern suitable to enable catalyst to distribute across the cathode current collector, the cathode flow distributor including at least one of a thermoplastic material of HDPE, Teflon, PEEK Kapton, Upilex, Imidex, Vectra, or Ultem; and
a membrane electrode assembly having a first side electrically coupled to the anode current collector and a second side electrically coupled to the cathode current collector.

19. A fuel cell stack comprising:
an in-plane conductive composite anode end plate, the anode end plate including an anode end plate current collector having a plurality of anode end plate flow channels, an anode end plate thermoplastic flow distributor, and an anode end plate thermoplastic film separator;
an in-plane conductive composite bipolar plate, the bipolar plate having a bipolar plate anode current collector having a plurality of bipolar plate anode flow channels, a bipolar plate anode thermoplastic flow distributor, a bipolar plate thermoplastic film separator, a bipolar plate cathode current collector having a plurality of bipolar plate cathode flow channels, and a bipolar plate cathode thermoplastic flow distributor;
an in-plane conductive composite cathode end plate, the cathode end plate including a cathode end plate current collector having a plurality of cathode end plate flow channels, a cathode end plate thermoplastic flow distributor, and a cathode end plate thermoplastic film separator;
a first membrane electrode assembly sandwiched between the anode end plate and the bipolar plate, the first membrane electrode assembly electrically coupling the anode end plate current collector and the bipolar plate anode current collector; and
a second membrane electrode assembly sandwiched between the cathode end plate and the bipolar plate, the second membrane electrode assembly electrically coupling the cathode end plate current collector and the bipolar plate cathode current collector.

20. The fuel cell stack of claim 19, wherein at least one of the current collectors is characterized in that the at least one of the current collectors includes:
a support layer, the support layer formed of a layer of Kapton-type material, the support layer including a plurality of micro-channels formed in the Kapton-type material;
a highly conductive layer adhered on a surface of the support layer;
a protective conductive layer formed on a surface of the layer opposite the surface of the support layer, wherein the protective conductive layer protects the highly conductive layer from at least one of oxidation and corrosion.

21. The fuel cell stack of claim 19, wherein at least one of the flow distributors includes at least one of a thermoplastic material of HDPE, Teflon, PEEK Kapton, Upilex, Imidex, Vectra, or Ultem.

22. The fuel cell stack of claim 19, wherein at least one of the flow distributors is mechanically machined.

23. The fuel cell stack of claim 19, wherein at least one of the flow distributors is injection molded.

24. The fuel cell stack of claim 19, wherein at least on one of the flow distributors is laser machined.

25. The fuel cell stack of claim 19, wherein at least one of the flow distributors is chemically etched.

26. The fuel cell stack of claim 19, wherein at least one of the flow distributors is die cut.

27. The fuel cell stack of claim 19, wherein at least one of the thermoplastic separators includes at least one of Imidex, Kapton, Upilex, PEEK, Teflon, Tefzel, HDPE, PE, and polypropylene.

28. The fuel cell stack of claim 27, wherein at least one of the thermoplastic separators is laser machined.

29. The fuel cell stack of claim 19, wherein at least one of the thermoplastic separators is chemically etched.

30. The fuel cell stack of claim 19, wherein at least one of the thermoplastic separators is die cut.
